(19) United States
(12) Patent Application Publication
(10) Pub. No.: US 2011/0289332 A1
(43) Pub. Date: Nov. 24, 2011

(54) METHOD AND APPARATUS FOR POWER MANAGEMENT IN A MULTI-PROCESSOR SYSTEM

(75) Inventors: Kiran Bondalapati, Los Altos, CA (US); William Alexander Hughes, San Jose, CA (US); Ming So, Danville, CA (US); Xiaogang Zheng, Sunnyvale, CA (US)

(73) Assignee: ADVANCED MICRO DEVICES, INC., Sunnyvale, CA (US)

(21) Appl. No.: 12/786,143

(22) Filed: May 24, 2010

(51) Int. Cl. G06F 1/26

(52) U.S. Cl. 713/323; 713/340

(57) ABSTRACT

Techniques for power management in a multi-processor system are disclosed. One of the processors in the system monitors whether all threads on all central processing unit (CPU) cores in the multi-processor system halt, and send a message to a south bridge to cause at least a part of the system to enter a low power state if all threads in the multi-processor system halt. The processor sends another message to the south bridge to cause at least a part of the multi-processor system to wake up if at least one thread on any CPU core in the multi-processor system exits a halt.

### FIELD OF INVENTION

This application is related to power management in a multi-processor computer system.

### BACKGROUND

Power management is an important issue in computer design. Power consumption and related cooling costs are a significant portion of the operation of computer systems. Units operating at high clock frequencies in a computer system such as central processing units (CPUs), main memories (e.g., random access memories (RAMs)), and chipsets typically consume more power than other units.

The Advanced Configuration and Power Interface (ACPI) specification defines several power states so that an operating system may transit a computer system and a processor to one of a plurality of power states. When a CPU core or thread on a processor enters an idle state, the system may enter a low power state. However, in a multi-processor system with multiple processors, currently there is no mechanism to detect that all the nodes in the system are idle, and hence to enter the power saving state.

### SUMMARY

Embodiments for power management in a multi-processor system are disclosed. One of the processors in the system monitors whether all threads on all central processing unit (CPU) cores in the multi-processor system halt, and sends a message to a device having a power management functionality to cause at least a part of the system to enter a low power state if all threads in the multi-processor system halt. The processor may send another message to the device to cause at least a part of the system to wake up if at least one thread on any CPU core in the multi-processor system exits a halt.

### BRIEF DESCRIPTION OF THE DRAWINGS

A more detailed understanding may be had from the following description, given by way of example in conjunction with the accompanying drawings wherein:

FIG. 1 shows an example structure of a processor in accordance with one embodiment;

FIG. 2 shows an example structure of a multi-processor system in accordance with one embodiment; and

FIG. 3 shows an example process for entering a low power state in accordance with one embodiment.

### DETAILED DESCRIPTION

The embodiments will be described with reference to the drawing figures wherein like numerals represent like elements throughout. In accordance with one embodiment, a multi-processor system enters a low power state (e.g., “C1E state”) when all CPU cores and threads in the system have halted and the boot strap processor (BSP) completes a handshake with a device having a power control functionalities, (e.g., a south bridge), in the system. The system exits the low power state by an interrupt, direct memory access (DMA) bus activity, a system reset (cold or warm reset), or the like. In the low power state, all CPU cores in the system halt; there is no DMA activity; a clock signal may be divided down or deactivated; and/or a link may be in a low power state or deactivated. Multiple levels of power states may be defined and the system may enter a deeper power saving state in several steps.

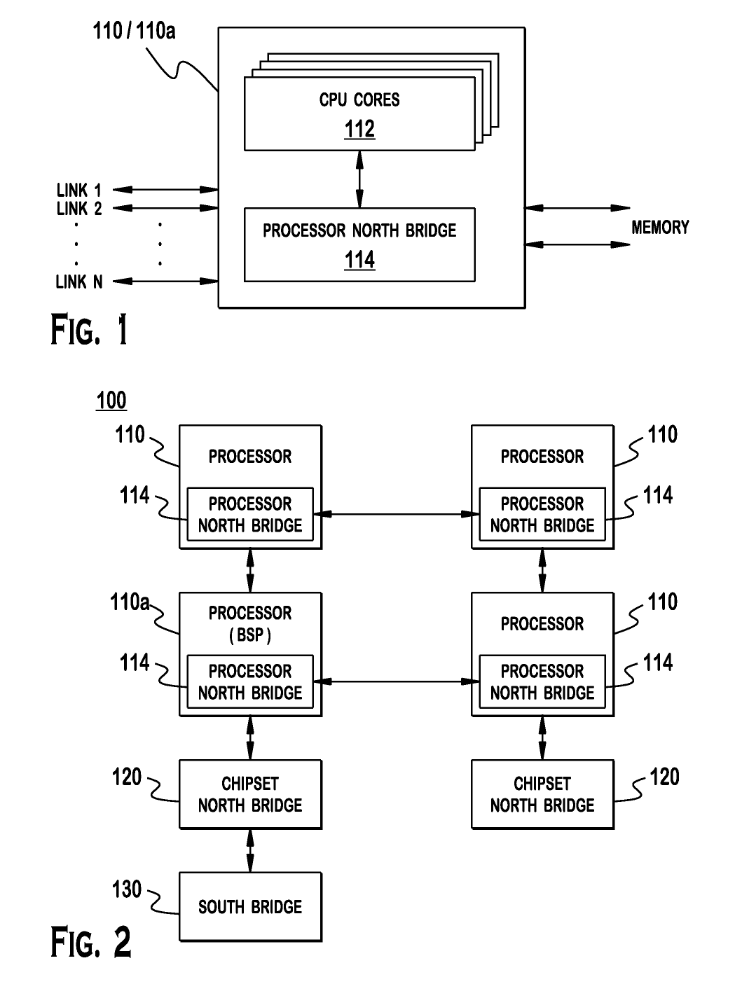

FIG. 1 shows an example structure of a processor 110/110a in accordance with one embodiment. A processor 110/110a is a package that contains one node. A node is an integrated circuit device that may include one or more CPU cores 112, a transaction routing block 114 (e.g., a processor north bridge), a plurality of links, and an interface to a memory (e.g., dynamic random access memory (DRAM)—not shown).

Each CPU core 112 may include an instruction execution logic (e.g., x86 instruction execution logic), a first level (L1) data cache, an L1 instruction cache, and optionally a second level (L2) cache. A CPU core 112 may execute zero, one or more than one thread in parallel. Each link may be configured to operate under any bus interface protocol, (for example, but not limited to, HyperTransport, PCI-Express, or any that are currently existing or developed in the future). The processor 110/110a may include a DRAM interface supporting, for example, a 64-bit, 128-bit, 256-bit double data rate 2 (DDR2) or DDR3 registered or unbuffered dual in-line memory module (DIMM) channel(s). The processor north bridge 114 routes transactions between the CPU cores 112, the links, and the DRAM interface. The processors 110/110a, a DRAM controller(s), and caches of the system comprise a coherent fabric, (i.e., the coherent fabric refers to the nodes, system memory, and coherent links used for communication between the nodes). A coherent link is a link configured for coherent inter-processor traffic between nodes.

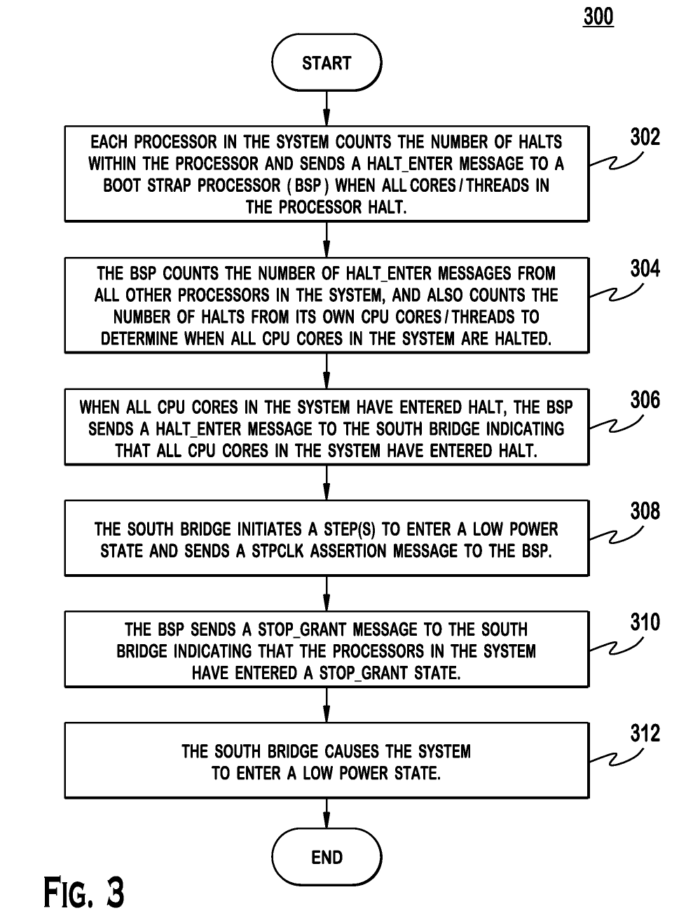

FIG. 2 shows an example structure of a multi-processor system 100 in accordance with one embodiment. The system 100 may include a plurality of processors 110/110a, one or more chipset north bridges 120, a south bridge 130, and any conventional devices that may be found in a conventional computer system.

Processors 110 are connected to the south bridge 130 via the BSP 110a (and via the chipset north bridge 120 connected to the BSP 110a). The chipset north bridge 120 and the south bridge 130 are transaction routing blocks to support devices running at different speeds on buses running at different speeds. The south bridge (also known as an input/output (I/O) hub) is a chipset that normally supports slower devices (such as I/O devices). The south bridge 130 may control power states of at least a part of the system 100 based on the messages and signals from the processors 110/110a and the chipset north bridges 120, and any other devices in the system 100.

The chipset north bridge 120 and the south bridge 130 have separate pins for power management signals that are used to enter and exit a low-power state, including ALLOW_LDTSTOP and LDTSTOP#. It should be noted that the name of the processor and chipset pins, ALLOW_LDTSTOP and LDTSTOP#, are provided as examples and different names may be used. ALLOW_LDTSTOP is a signal driven by all of the chipset north bridges 120 in the system 100, and received by the south bridge 130 such that it is asserted when all chipset north bridges 120 are in idle and deasserted when there is at least one chipset north bridge 120 which is not in idle. When ALLOW_LDTSTOP is asserted, the south bridge 130 is permitted to assert LDTSTOP#, which is used to enable and disable the links. When ALLOW_LDTSTOP is deasserted, the south bridge 130 deasserts LDTSTOP#. The chipset north bridges 120 deassert ALLOW_LDTSTOP when an interrupt is received and keeps it deasserted until an interrupt message is passed to a processor 110/110a. ALLOW_LDTSTOP is also deasserted when there is direct memory access (DMA) traffic or any other pending bus transactions, etc.

The processors 110/110a and the south bridge 130 may also have separate pins for power management signals that are used to enter and exit a low-power state, including IDLE_EXIT#. It should be noted that the pin name, IDLE_EXIT#, is provided as example and a different name may be used. IDLE_EXIT# is a wired-OR signal driven by all processors 110/110a in the system and connected to the south bridge 130. IDLE_EXIT# is asserted by a processor 110/110a, for example, when it has an interrupt pending on a CPU core that is in a stop_grant state, (i.e., low power state), or triggered by a timer, or the like, and it causes a low power exit event in the south bridge 130.

It should be noted that the processor 110/110a and the system 100 shown in FIGS. 1 and 2 are provided as an example, not as a limitation. Even though FIG. 2 shows four processors 110/110a and two chipset north bridges 120, the system may include any number of processors 110/110a and chipset north bridges 120, and the embodiments disclosed herein are equally applicable to a system configured differently. For example, the chipset north bridge 120 and the south bridge 130 may be integrated into one or fewer devices, their functionalities may be implemented by more or less components or devices, and/or some of the functionalities, including power management functionalities, may be performed by a separate or different device.

FIG. 3 shows an example process 300 for entering a low power state in accordance with one embodiment. Each processor 110 in the system counts the number of halts within the processor 110 and sends a preconfigured message (hereinafter referred to as “HALT_ENTER message”) to the BSP 110a when all CPU cores/threads in the processor 110 halt (302). Conventionally, when a thread on a particular CPU core enters an idle state, the operating system (OS) executes an HALT instruction, which is a micro-code instruction, and at the end of the execution of the HALT instruction a special bus cycle, (i.e., HALT signal), is broadcast. In accordance with one embodiment, each processor 110 suspends sending a HALT message after executing the HALT instruction, but sends a HALT_ENTER message when all CPU cores/threads in the processor 110 enter an idle state.

The BSP 110a counts the number of HALT_ENTER messages from all other processors 110 in the system, and also counts the number of halts from its own CPU cores/threads to determine when all CPU cores in the system 100 are halted (304). When all CPU cores in the system 100 have entered halt, the BSP 110a sends a preconfigured message, (e.g., a HALT_ENTER message), to the south bridge 130 indicating that all CPU cores in the system 100 have entered halt (306).

Optionally, all CPU cores may flush their caches if cache flush on halt (CFOH) is enabled, and/or the system may wait for the CPU cores to save their state to memory and disconnect CPU power source, before the BSP 110a sends the preconfigured message.

When the south bridge 130 receives the HALT_ENTER message from the BSP 110a, the south bridge 130 initiates a step(s) to enter a low power state, (for example, by performing an internal P_LVL3 read), and sends a STPCLK assertion message to the BSP 110a (308). The BSP 110a manages the STPCLK assertion message on behalf of all CPU cores in the system 110, (i.e., the BSP 110a receives a single STPCLK message from the south bridge 130 and broadcasts it to other processors 110). The processors 110 sends a preconfigured message (hereinafter referred to as “STOP_GRANT message”) to the BSP 110a in response to the STPCLK message, and the BSP 110a sends a single message, (e.g., “STOP_GRANT message”), to the south bridge 130 indicating that the processors 110/110a in the system 100 have entered a stop_grant state (310). The STPCLK and STOP_GRANT messages are handled by the BSP 110a on behalf of all CPU cores in the system 100. After receiving the STOP_GRANT message from the BSP 110a, the south bridge 130 asserts the LDTSTOP# signal and causes at least a part of the system 100 to enter a low power state (312). The low power state may include, but is not limited to, at least one of powering off the links, putting memory into self-refresh, reducing processor north bridge internal power by turning off clocks or reducing voltage, or turning power for some parts of the processor.

If any CPU core in the system 100 receives an interrupt before entering a stop_grant state, it may send a preconfigured message (hereinafter referred to as “HALT_EXIT message”) to the south bridge 130. If any CPU core in the system receives an interrupt after entering a stop_grant state, it may send a preconfigured message (hereinafter referred to as “INT_PENDING message”) to the south bridge 130. The HALT_EXIT message and the INT_PENDING messages are treated as a break event. If the south bridge 130 receives a HALT_EXIT message or an INT_PENDING message or any other break event occurs during the interval between receiving the HALT_ENTER message and receiving the STOP_GRANT message from the BSP 110a, the south bridge 130 may send a STPCLK deassertion message to the BSP 110a to abort the process. If the south bridge 130 receives a HALT_EXIT or INT_PENDING message or any other break event occurs after receiving the STOP_GRANT message, the south bridge 130 may skip asserting LDTSTOP# and send STPCLK deassertion message to the BSP 110a to wake up at least a part of the system.

During the low power state, LDTSTOP# may be deasserted periodically to keep the links refreshed. As long as the links are refreshed at a period that is less than a configured period, an extended link start-up delay may be avoided on wake-up. The time of LDTSTOP# assertion and deassertion between refreshes may be set by corresponding timers.

While in the low power state, memory scrubbing may be performed. Memory scrub events may not cause an exit from the low power state. In accordance with one embodiment, in order to minimize the power overhead of taking the DRAM in and out of self-refreshing during the low power state, the memory scrub events may be accumulated so that they may be replayed as a group at times that can minimize additional idle power overhead, such as during the periodic link refresh.

The low power state is exited by an interrupt, DMA activity, a system reset (cold or warm reset), etc. An interrupt occurring internally within a processor 110/110a in a low power state causes the processor 110/110a to assert IDLE_EXIT#. This is a break event in the south bridge 130. The south bridge 130 then executes an exit from the low power state. The processor 110/110a may also send the INT_PENDING message to the south bridge 130, following a deassertion of ALLOW_LDTSTOP.

If an interrupt received by a chipset north bridge 120 on a secondary I/O chain (a chain not involving the BSP in the coherent fabric), the interrupt may pass through the coherent fabric. This requires that LDTSTOP# be deasserted. A chipset north bridge 120 receiving an interrupt deasserts ALLOW_LDTSTOP. ALLOW_LDTSTOP remains deasserted from the detection of the interrupt until the interrupt message is sent from the chipset north bridge 120 to a processor 110/110a. The south bridge 130, upon detecting ALLOW_LDTSTOP deasserted, deasserts LDTSTOP#. This allows the interrupt message to move over the coherent fabric.

When the south bridge 130 sees ALLOW_LDTSTOP asserted again (i.e., the interrupt message from the chipset north bridge 120 has entered the coherent fabric at this time), the south bridge 130 starts a counter and holds LDTSTOP# deasserted until the counter expires. The interrupt message will also cause the processor 110/110a receiving it to assert IDLE_EXIT#, which causes the south bridge break event.

It should be noted that the message names above are provided as examples and different names may be used.

Currently, the vast majority of electronic circuits are designed and manufactured by using software (e.g., hardware description language (HDL)). HDL is a computer language for describing structure, operation, and/or behavior of electronic circuits. The devices 110, 110a, 120, 130, (i.e., the electronic circuits), may be designed and manufactured by using software (e.g., HDL). HDL may be any one of the conventional HDLs that are currently being used or will be developed in the future. A set of instructions are generated with the HDL to describe the structure, operation, and/or behavior of the devices. The set of instructions may be stored in any kind of computer-readable storage medium.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

What is claimed is:

1. A method for power management in a multi-processor system, the method comprising:
monitoring whether all threads on all central processing unit (CPU) cores in the multi-processor system halt; and
sending a message to cause at least a part of the system to enter a low power state on a condition that all threads in the multi-processor system halt.

2. The method of claim 1 wherein the message is sent to a south bridge on behalf of all processors in the system.

3. The method of claim 1 further comprising:
sending a second message to cause at least a part of the multi-processor system to wake up on a condition that at least one thread on any CPU core in the multi-processor system exits a halt.

4. The method of claim 3 wherein the second message is sent to a south bridge on behalf of all processors in the system.

5. The method of claim 1 further comprising:
sending a second message to cause at least a part of the multi-processor system to wake up on a condition that an interrupt is pending on any CPU core in the multi-processor system.

6. The method of claim 1 comprising:
asserting a signal that is connected to a device having power management functionalities and is driven by all processors in the multi-processor system on a condition that an interrupt is pending on a CPU core that is in a stop grant state.

7. The method of claim 1 further comprising:
performing a link refresh periodically while in the low power state.

8. The method of claim 7 further comprising:
performing memory scrubbing during the periodic link refresh.

9. A processor for power management in a multi-processor system, the processor comprising:
at least one central processing unit (CPU) core; and
a transaction routing block, wherein the processor is configured to monitor whether all threads on all CPU cores in the multi-processor system halt and send a message to cause at least a part of the system to enter a low power state on a condition that all threads in the multi-processor system halt.

10. The processor of claim 9 wherein the message is sent to a south bridge on behalf of all processors in the system.

11. The processor of claim 9 wherein the processor is configured to send a second message to cause at least a part of the multi-processor system to wake up on a condition that at least one thread on any CPU core in the multi-processor system exits a halt.

12. The processor of claim 11 wherein the second message is sent to a south bridge on behalf of all processors in the system.

13. The processor of claim 9 wherein the processor is configured to send a second message to cause at least a part of the multi-processor system to wake up on a condition that an interrupt is pending on any CPU core in the multi-processor system.

14. The processor of claim 9 wherein the processor is configured to assert a signal that is connected to a device having power management functionalities and is driven by all processors in the multi-processor system on a condition that an interrupt is pending on a CPU core that is in a stop grant state.

15. The processor of claim 9 wherein the processor is configured to perform a link refresh periodically while in the low power state.

16. The processor of claim 15 wherein the processor is configured to perform memory scrubbing during the periodic link refresh.

17. A computer-readable storage medium storing a set of instructions for execution by a general purpose computer to perform power management in a multi-processor system, the set of instructions comprising:
a monitoring code segment for monitoring whether all threads on all central processing unit (CPU) cores in the multi-processor system halt; and
a transmitting code segment for sending a message to cause at least a part of the system to enter a low power state on a condition that all threads in the multi-processor system halt.
